(19) United States
(12) Patent Application Publication
(10) Pub. No.: US 2007/0137055 A1
(43) Pub. Date: Jun. 21, 2007

(54) Compass

(76) Inventor: Jui-An Tsai, Tao Yuan City (TW)

Correspondence Address: TROXELL LAW OFFICE PLLC;SUITE 1404, 5205 LEESBURG PIKE, FALLS CHURCH, VA, 22041, US

(21) Appl. No.: 11/304,734

(22) Filed: Dec. 16, 2005

(51) Int. Cl. G01C 17/08

(52) U.S. Cl. 33/364

(57) ABSTRACT

A compass including a container for liquid, a floating body, a vertical shaft, a pointer and an ornament such as pens is disclosed. The container is disposed horizontally with an axial hole on top surface thereof while the floating body such as a pen holder floats on liquid inside the container. The vertical shaft vertically arranged on a center line of the floating body. Moreover, the vertical shaft inserts through the axial hole and connects with an extension rod. The pointer and the ornament are further loaded on the extension rod. A magnetized bar is transversely disposed on the floating body or the vertical shaft and a central point of the magnetized bar aligns the center line of the floating body so that the S pole of the magnetized bar faces the direction that the pointer indicates. By the buoyancy generated of the floating body and the guidance of the axial hole, the magnetized bar with a central shaft suspends freely so as to align itself accurately with earth's magnetic field and further drive the pointer or the ornament. Thus the present invention has both functions of direction indication and decorative effect.

### BACKGROUND OF THE INVENTION

The present invention relates to a compass, especially to a compass that uses buoyancy of a floating body to replace pointer shafts of conventional compasses for indicating directions and decorative effect.

The compass available now is a small disc enclosed in a housing. A transparent window is on top surface for users to observe the direction while a shaft as well as a needle is arranged inside the compass. The friction between the needle and the shaft should be minimized so as to make the needle in a free and balanced status for finding earth's magnetic field and pointing in a northerly or southerly direction. However, conventional compasses only indicate directions with a small needle inside a disc. It has no decorative effect.

### SUMMARY OF THE INVENTION

Therefore it is a primary object of the present invention to provide a compass that includes a floating body inside a container. A vertical shaft is arranged on a center line of the floating body and is inserted through an axial hole on top surface of the container, connecting with an extension rod. A pointer is loaded on the extension rod. A magnetized bar is transversely disposed on the floating body or the vertical shaft and a central point of the magnetized bar aligns the center line of the floating body so that the S pole of the magnetized bar faces the direction that the pointer indicates. By the buoyancy generated of the floating body and the guidance of the axial hole, the magnetized bar with a central shaft suspends freely so as to align itself accurately with earth's magnetic field and further drive the pointer to indicate directions outside the container.

It is another object of the present invention to provide a compass having the pointer with various shapes such as arrowhead arranged outside the container for replacing conventional magnetized needles of compasses for increasing decorative effect of the present invention.

It is a further object of the present invention to provide a compass having ornaments such as pen holders, pens or photo frames loaded on the vertical shaft or the extension rod for increasing decorative effect of the present invention.

It is a further object of the present invention to provide a compass having a leakproofing structure between the vertical shaft of the floating body and an axial hole on the container. A tubular projective edge extends from the axial hole toward the inner space of the container. By controlling the amount of the liquid inside the container, the surface of the liquid is lower than the rear end of the tubular projective edge of the axial hole no matter the container is disposed vertically, reversely or laterally. Thus the liquid won't flow or penetrate into the gap between the vertical shaft and axial hole and the liquid won't leak from the axial hole. Therefore, the present invention is easy to pack or transport.

### BRIEF DESCRIPTION OF THE DRAWINGS

FIG. 1 is a perspective view of an embodiment in accordance with the present invention;

FIG. 2 is an explosive view of the embodiment in FIG. 1;

FIG. 3 is a cross-sectional view of the embodiment in FIG. 1;

FIG. 4 is a perspective view of another embodiment in accordance with the present invention;

FIG. 5 is an explosive view of the embodiment in FIG. 4;

FIG. 6 is a cross-sectional view of the embodiment in FIG. 4.

### DETAILED DESCRIPTION OF THE PREFERRED EMBODIMENT

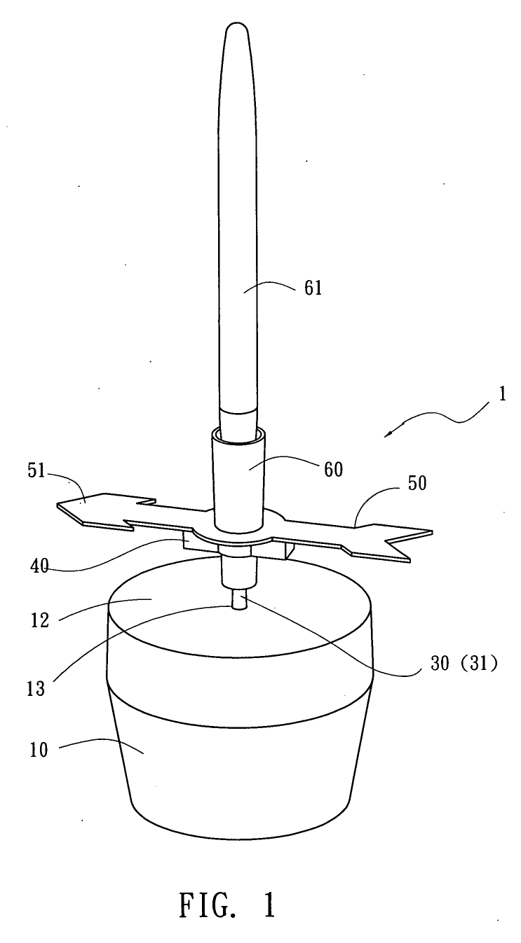

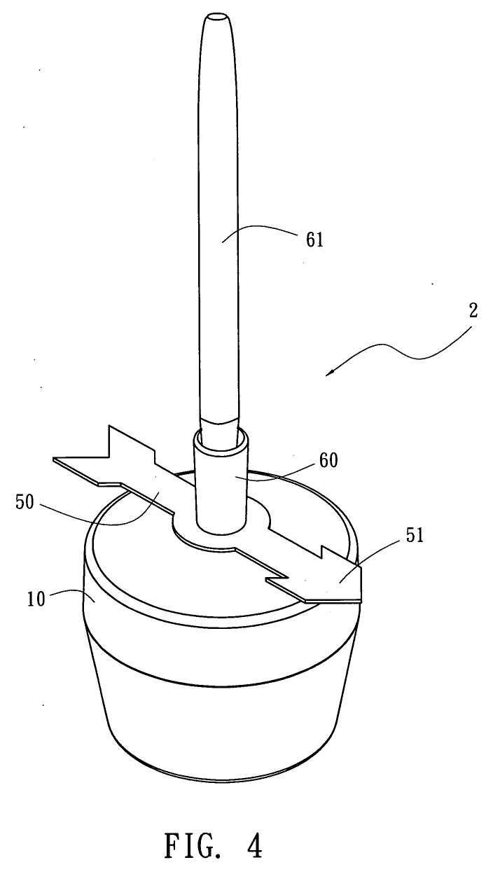

Refer from FIG. 1 to FIG. 3 for an embodiment of the present invention and from FIG. 4 to FIG. 6 for another embodiment, a compass 1, 2 in accordance with the present invention includes a container 10 for liquid, a floating body 20, a vertical shaft 30, a magnetized bar 40, an pointer 50 and an ornament 60. The container 10 for liquid is a housing installed horizontally, transparent or not, with liquid 11 such as water or oil (wax) therein. A shaft axial hole 13 is disposed on top surface 12 of the container 10. The floating body 20 is a hollow enclosed shell that floats on the liquid 11 inside the container 10. The shape of the floating body 20 is preferably symmetrical such as disk so that the floating body 20 has a center line 21. The vertical shaft 30 is vertically arranged on the floating body 20, aligning with the center line 21 of the floating body 20. Moreover, the vertical shaft 30 inserts through the axial hole 13 on top surface 12 of the container 10 and connects with an extension rod 31. The extension rod 31 can also be integrated with the vertical shaft 30. The diameter of the axial hole 13 is a bit larger than that of the vertical shaft 30 so as to make the vertical shaft 30 move vertically inside the axial hole 13. The assembly of the floating body 20 and the vertical shaft 30 (or the extension rod 31) moves freely inside the axial hole 13 due to the buoyancy.

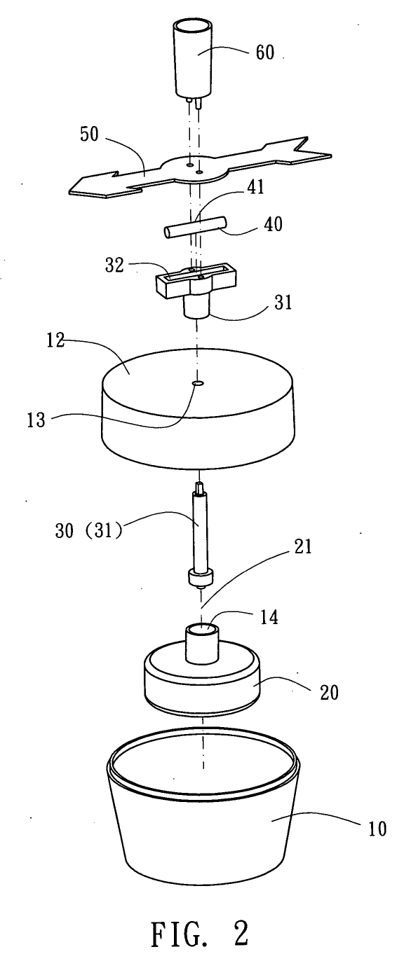

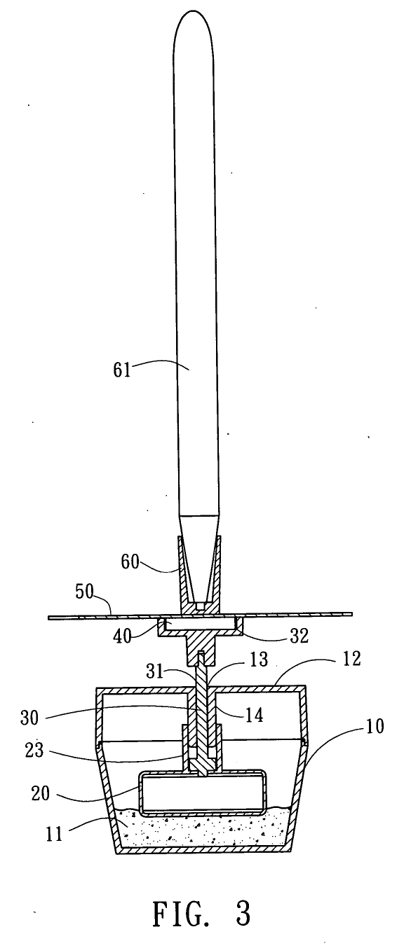

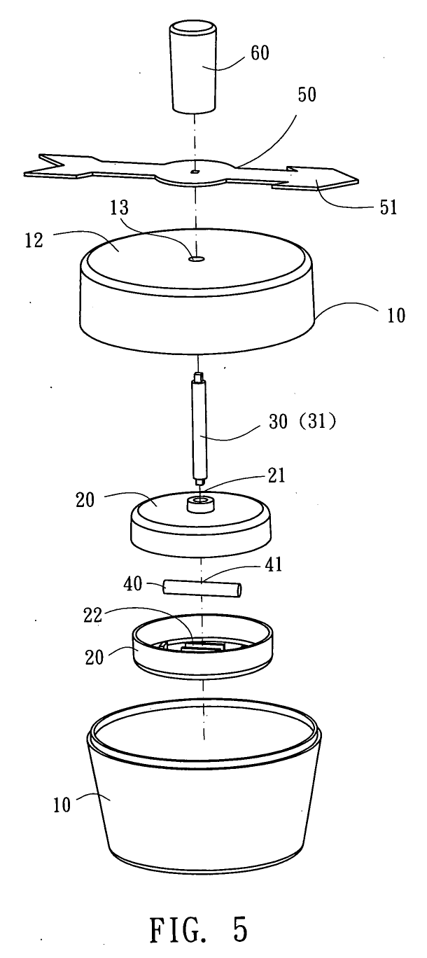

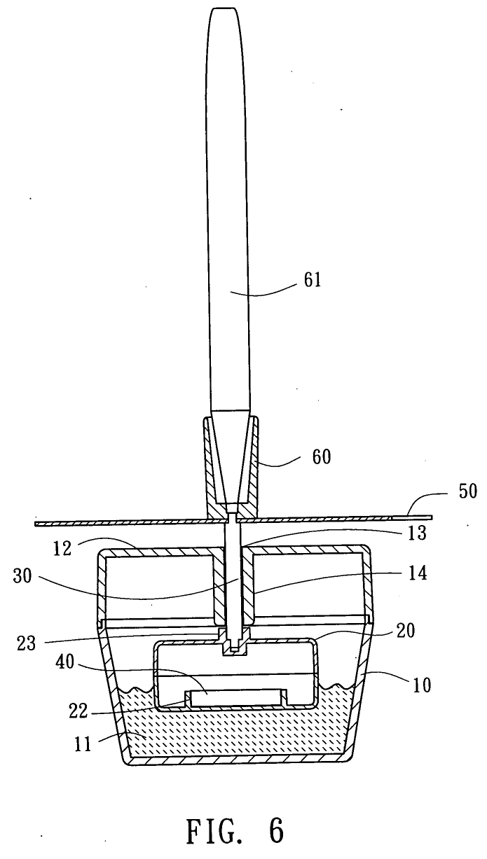

The magnetized bar 40 is transversely disposed on the floating body 20, the vertical shaft 30 or the extension rod 31. Refer to FIG. 2 & FIG. 3, a transverse slot 32 is mounted on the vertical shaft 30 for accommodation of the magnetized bar 40. Refer to FIG. 5 & FIG. 6, a transverse slot 22 is mounted on the floating body 20 for accommodation of the magnetized bar 40 while a central point 41 (interface of N and S poles) of the magnetized bar 40 aligns the center line 21 of the floating body 20 so as to form a central shaft of the magnetized bar 40. By the buoyancy generated of the floating body 20, the magnetized bar 40 suspends freely so as to align itself accurately with earth's magnetic field. Further the assembly of the of the floating body 20 and the vertical shaft 30 or the extension rod 31 moves synchronously with the magnetized bar 40 so as to indicate the direction of the magnetic north of a planet's magnetosphere.

The pointer 50 is transversely arranged on the vertical shaft 30 or the extension rod 31 above the floating body 20. According to users' preference, the pointer 50 is designed with various shapes such as arrowhead sign in FIG. 1, FIG. 2, FIG. 4 or FIG. 5. The indicating sign 51 of the pointer 50 such as the arrowhead turns to the S pole of the magnetized bar 40 so that the pointer 50 moves synchronously with the magnetized bar 40. Because the volume of the pointer 50 is larger than conventional needle of the compass and the pointer 50 is disposed outside the container 10, it is obvious to see the pointer 50. The pointer 50 not only replaces small magnetized needle inside the housing of traditional compass but also provides decorative effect of the compass 1 in accordance with the present invention. Moreover, the magnetized bar 40 can be arranged under the pointer 50, as shown in FIG. 2 & FIG. 3, or inside the floating body 20, as shown in FIG. 5 & FIG. 6. Thus the magnetized bar 40 is shielded to increase the mystery of the compass 1, 2 in accordance with the present invention.

Moreover, the ornament 60 is loaded on the vertical shaft 30 or the extension rod 31 projecting outward the container 10. The ornament 60 can be a pen-stab for holding pens 61, as shown in figure, a photo frames (not shown in figure), or other objects so as to increase the decorative effect of the compass 1, 2 of the present invention.

Refer to FIG. 3 & FIG. 6, a leakproofing structure is disposed between the vertical shaft 30 and axial hole 13. For example, a tubular projective edge 14 extends from the axial hole 13 toward the inner space of the container 10 while another tubular projective edge 23 is on locking area between the vertical shaft 30 and the floating body 20. The amount of the liquid 11 inside the container 11 is controlled in a certain range so as to make the surface of the liquid 11 not flow over the rear end of the tubular projective edge 14 of the axial hole 13 no matter the container 10 is disposed vertically, reversely or laterally. Thus the liquid 11 won't flow or penetrate into the gap between the vertical shaft 30 and axial hole 13. Because the liquid 11 won't leak from the axial hole 13, compasses 1, 2 of the present invention are easy to pack or transport.

What is claimed is:

1. A compass comprising a container for liquid, a floating body, a vertical shaft, a magnetized bar, a pointer and an ornament, wherein
the container for liquid is a housing disposed horizontally with a liquid therein and an axial hole on top surface thereof;
the floating body is a hollow enclosed shell that floats on the liquid inside the container, having a center line;
the vertical shaft is arranged on a center line of the floating body and is inserted through an axial hole on top surface of the container, connecting with an extension rod while the diameter of the vertical shaft is a bit smaller than that of the axial hole so that the vertical shaft move vertically inside the axial hole;
the magnetized bar is transversely disposed inside the floating body, the vertical shaft or the extension rod and a central point of the magnetized bar aligns the center line of the floating body; and
the pointer is loaded on the vertical shaft or the extension rod of the floating body and the direction that the pointer indicates faces S pole of the magnetized bar so that the pointer moves along with the magnetized bar;
thereby the magnetized bar having a central shaft suspends freely so as to align itself accurately with earth's magnetic field and further drive the pointer or the ornament.

2. The compass as claimed in claim 1, wherein there is no limitation on shape of the container and the container is able to be transparent or opaque.

3. The compass as claimed in claim 1, wherein the floating body is preferably symmetrical with a center line.

4. The compass as claimed in claim 1, wherein the floating body is a hollow disc-like shell.

5. The compass as claimed in claim 3, wherein the floating body is a hollow disc-like shell.

6. The compass as claimed in claim 1, wherein the ornament is a pen holder or a photo frame.

7. The compass as claimed in claim 1, wherein a leakproofing structure is disposed between the vertical shaft and axial hole of the container.

8. The compass as claimed in claim 6, wherein the leakproofing structure having a tubular projective edge that extends from the axial hole toward the inner space of the container and another tubular projective edge that is on locking area between the vertical shaft and the floating body.

9. The compass as claimed in claim 1, wherein the amount of the liquid inside the container is certain so that the surface of the liquid is lower than the rear end of the tubular projective edge of the axial hole no matter the container is disposed vertically, reversely or laterally.

10. The compass as claimed in claim 7, wherein the amount of the liquid inside the container is certain so that the surface of the liquid is lower than the rear end of the tubular projective edge of the axial hole no matter the container is disposed vertically, reversely or laterally.
